(19) United States
(12) Patent Application Publication
(10) Pub. No.: US 2008/0190030 A1
(43) Pub. Date: Aug. 14, 2008

(54) Prefabricated Windows and Doors System

(76) Inventors: Tae-Ho Cheon, Gyeonggi-do (KR); Won-Jin Kim, Seoul (KR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/066,209

(22) PCT Filed: Sep. 8, 2006
(86) PCT No.: PCT/KR2006/003573

§ 371 Date: Mar. 7, 2008

(30) Foreign Application Priority Data
Sep. 8, 2005 (KR) 10-2005-0083719

(51) Int. Cl. E05D 15/06

(52) U.S. Cl. 49/425

(57) ABSTRACT

A prefabricated windows and doors system includes a window frame including upper and lower frame, a window holder suspended from the upper frame, a window support slidably inserted into the lower guide recess to support a roller, which is rotatable, on the rail, and a window coupled to the window holder and the window support, and being attachable to or removable from the window holder and the window support. The upper frame has an upper guide recess, and the lower frame contains a stepped portion to have a staircase shape and contains a lower guide recess on a sidewall of the stepped portion. A guide bar extended in a sliding direction of the window may be further installed in the upper guide recess. A suspension portion of the window holder may have a ring shape surrounding the guide bar.

### TECHNICAL FIELD

The present invention relates to a prefabricated windows and doors system, and more particularly, to a prefabricated windows and doors system having at least two windows.

### BACKGROUND ART

Generally, when a windows and doors system is installed in a structure, after a space for a window frame in which a window frame may be disposed is prepared in the structure, the window frame is fixed in the space for the window frame, and a window is coupled to the window frame. Hereinafter, a conventional windows and doors system will be illustrated with reference to the accompanying drawings.

FIG. 1 is a cross-sectional view illustrating a conventional windows and doors system.

Referring to FIG. 1, a windows and doors system 10 includes a window frame 20 and a window 40.

The window frame 20 has a quadrangular shape on the whole, and is fixed to a structure 5. An upper frame 21 and a lower frame 31 of the window frame 20 have an upper guide recess 23 and a lower guide recess 33, respectively, both of which are formed parallel to each other and guide movements of a window 40. A guide bar 35 that guides movements of a roller 45 installed at a bottom surface of the window 40 is formed in the lower guide recess 33.

In order to couple the window 40 to the window frame 20, after inserting an upper portion of the window 40 into the upper guide recess 23 with the window 40 tilted, a lower portion of the window 40 is inserted into the lower frame 31. Then, the lower portion of the window 40 is inserted into the lower guide recess 33 due to a weight of the window 40. The window 40 coupled to the window frame 20 moves left and right by revolution of the roller 45 to be opened or closed.

In order to fix the window frame 20 to the structure 5, after preparing a space for a window frame corresponding to a size of the window frame 20 in the structure 5, the window frame 20 is disposed in the space for the window frame. However, because the structure 5 generally includes cement, concrete or wood, the space does not always correspond to the size of the window frame 20. In that case, generally, the space is not re-formed to a correct size, but the window frame 20 is forcibly fitted into the space, which is not formed to correspond to the size of the window frame 20. The window frame 20 forcibly fitted into the space may undergo deformation such as bending or distortion. Further, the window 40 may not be coupled to the window frame 20 that has been deformed to exceed a given error degree.

Generally, the window frame 20 has a quadrangular shape of which the corners have angles of about 90°. Even though the space having a volume similar to that of the window frame 20 is formed in the structure 5, corner angles of the window frame 20 should be substantially the same as that of corner angles of the space. However, when the space is not initially correctly formed in the structure 5, or when the space no longer correctly corresponds to the shape of the window frame 20 because of circumstances such as an earthquake or ground subsidence, the above-mentioned problems may be generated.

Additionally, a plurality of the lower guide recesses 33 of the conventional windows and doors system 10 are formed to substantially the same height. That is, the lower frame 31 has a single-level structure. When rainwater flows into the lower guide recess 33, the rainwater pools in the lower frame 31. When the rainwater pooling in the lower frame 31 overflows, the rainwater may flow into the interior of a room. Further, substances such as dust flowing into the lower guide recesses 33 do not drain out of the lower guide recesses 33 but stick to the lower guide recesses 33.

Furthermore, the conventional windows and doors system 10 has such problems in that opening and closing of the window 40 are not smooth, the roller 45 is frequently damaged, and the conventional windows and doors system 10 is affected by deformation of the window frame 20 because the weight of the window 40 is supported by the lower frame 31.

### DISCLOSURE OF THE INVENTION

Technical Problem

The present invention provides a prefabricated windows and doors system of good performance with respect to soundproofing, thermal insulation, rainwater inflow, cleanliness, etc.

The present invention also provides a prefabricated windows and doors system in which a window may be easily coupled to the windows and doors system and may be easily replaced with another one.

Technical Solution

According to one aspect of the present invention, there is disclosed a prefabricated windows and doors system. The prefabricated windows and doors system includes a window frame, a window holder, a window support and a window. The window frame includes an upper frame and a lower frame. The upper frame has an upper guide recess formed in a sliding direction of a window. The lower frame contains a stepped portion to have a staircase shape and contains a lower guide recess on a sidewall of the stepped portion. A rail is formed in the lower guide recess. The window holder is slidably inserted into the upper guide recess to be suspended from the upper frame. The window support is slidably inserted into the lower guide recess to support a roller, which is rotatable, on the rail. The window is coupled to the window holder and the window support, and is attachable to or removable from the window holder and the window support.

In an example embodiment of the present invention, the upper guide recess may include a sliding portion having a cylindrical shape and a neck portion being extended downward from the sliding portion and having a width smaller than that of the sliding portion.

In an example embodiment of the present invention, the window holder may include a suspension portion sliding along the upper guide recess and a holding portion being extended downward from the suspension portion and having a quadrangular frame shape with a width substantially the same as that of an upper part of the window so that the window may be fixed to the holding portion by being forcibly fitted.

In an example embodiment of the present invention, the system may further include a guide bar extended in the sliding direction of the window in the upper guide recess. The suspension portion may have a ring shape surrounding the guide bar.

In an example embodiment of the present invention, the window support may include a roller holder for supporting the roller, which is rotatable, and a support member being extended outward of the lower guide recess and having a quadrangular frame shape with a width substantially the same as that of a lower part of the window so that the window may be fixed to the support member by being forcibly fitted.

In an example embodiment of the present invention, the system may further include a guide cover having a cross-section of an ‘L’ shape rotated clockwise by about 90° and being installed on a vertical wall of the stepped portion to define a boundary of the lower guide recess.

In an example embodiment of the present invention, the lower part of the window may have a stepped shape corresponding to a shape of the guide cover.

In an example embodiment of the present invention, the system may further include a lower guide cover and an upper guide. The lower guide cover may have a cross-section of an ‘L’ shape and be installed on the vertical wall of the stepped portion to support the roller. The upper guide cover may have a cross-section of an ‘L’ shape rotated clockwise by about 90° and be installed on the vertical wall of the stepped portion and over the lower guide cover with a width larger than that of the lower guide cover to define a boundary of the lower guide recess.

In an example embodiment of the present invention, the window frame may further include side frames for connecting each end of the upper frame and each end of the lower frame, respectively, to support the upper and the lower frames.

According to another aspect of the present invention, there is disclosed a prefabricated windows and doors system. The prefabricated windows and doors system includes a window frame, a window holder, a window support and a window. The window frame includes an upper frame having an upper guide recess formed in a sliding direction of a window and a lower frame having a lower guide recess formed in the sliding direction of the window. A rail is formed in the lower guide recess. The window holder is slidably inserted into the upper guide recess to be suspended from the upper frame. The window support is slidably inserted into the lower guide recess to support a roller, which is rotatable, on the rail. The window is coupled to the window holder and the window support. The window is attachable to or removable from the window holder and the window support.

According to still another aspect of the present invention, there is disclosed a prefabricated windows and doors system. The prefabricated windows and doors system includes a window frame, a window support and a window. The window frame includes an upper frame having an upper guide recess formed in a sliding direction of a window and a lower frame containing a stepped portion to have a staircase shape and containing a lower guide recess on a sidewall of the stepped portion. A rail is formed in the lower guide recess. The window support is slidably inserted into the lower guide recess to support a roller, which is rotatable, on the rail. The window is coupled to the window holder and the window support. A lower part of the window is attachable to or removable from the window support and an upper part of the window is fitted into the upper guide recess.

According to the present invention, the weight of the window may be distributed to the upper frame and the lower frame. Additionally, the window may be easily inserted into a space between the window holder and the window support, and may be easily replaced with another one. Further, any influence of sloping or distortion of the window frame may be minimized. Furthermore, effects such as soundproofing, thermal insulation, prevention of rainwater inflow, etc. may be obtained.

### BRIEF DESCRIPTION OF THE DRAWINGS

The above and other advantages of the present invention will become more apparent by describing in detail example embodiments thereof with reference to the accompanying drawings, in which:

FIG. 1 is a cross-sectional view illustrating a conventional windows and doors system;

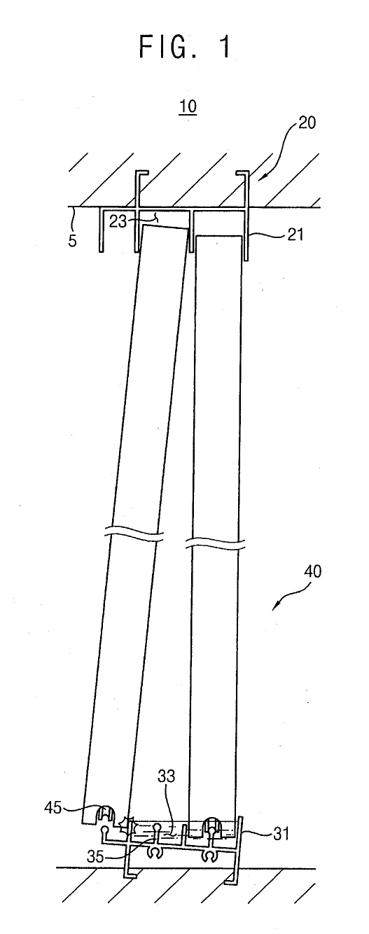

FIG. 2 is a perspective view illustrating a prefabricated windows and doors system in accordance with one example embodiment of the present invention;

FIG. 3 is a cross-sectional view illustrating the prefabricated windows and doors system shown in FIG. 2;

FIG. 4 is a cross-sectional view illustrating a prefabricated windows and doors system in accordance with another example embodiment of the present invention;

FIG. 5 is a cross-sectional view illustrating a prefabricated windows and doors system in accordance with another example embodiment of the present invention; and

FIG. 6 is a cross-sectional view illustrating a prefabricated windows and doors system in accordance with still another example embodiment of the present invention.

### BEST MODE FOR CARRYING OUT THE INVENTION

It should be understood that the example embodiments of the present invention described below may be varied modified in many different ways without departing from the inventive principles disclosed herein, and the scope of the present invention is therefore not limited to these particular following embodiments. Rather, these embodiments are provided so that this disclosure will be through and complete, and will fully convey the concept of the invention to those skilled in the art by way of example and not of limitation.

Hereinafter, the present invention will be described in detail with reference to the accompanying drawings.

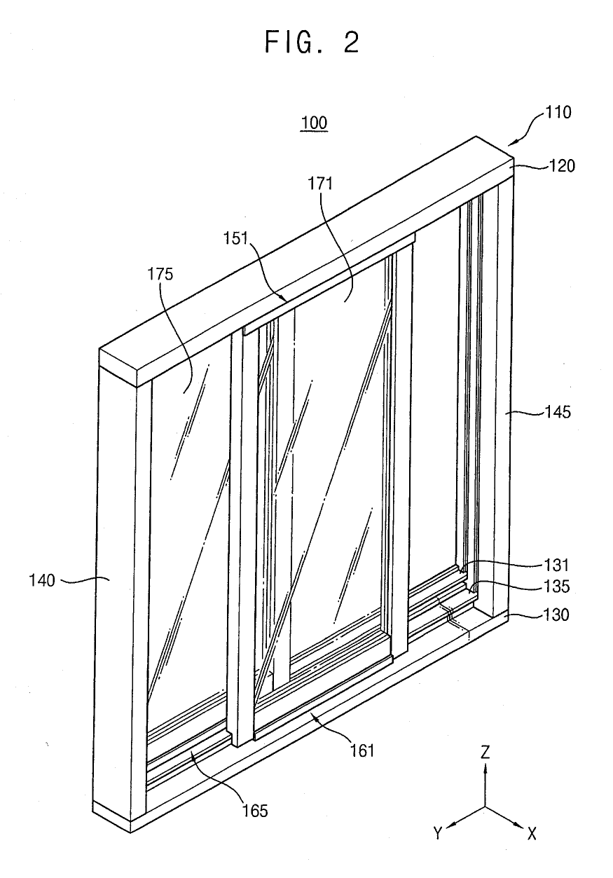

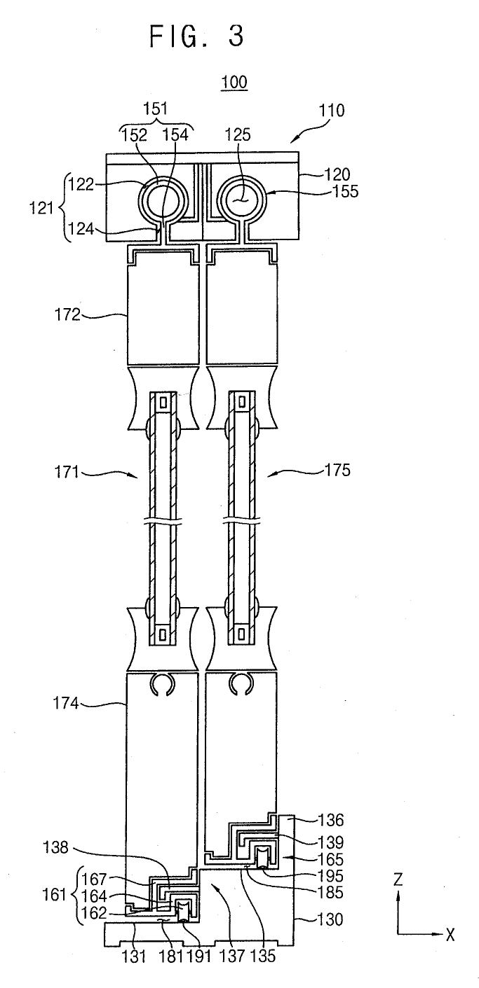

FIG. 2 is a perspective view illustrating a prefabricated windows and doors system in accordance with one example embodiment of the present invention, FIG. 3 is a cross-sectional view illustrating the prefabricated windows and doors system shown in FIG. 2.

Referring to FIGS. 2 and 3, a prefabricated windows and doors system 100 includes a window frame 110, a first window holder 151, a second window holder 155, a first window support 161, a second window support 165, a first window 171 and a second window 175. The window frame 110 has an upper frame 120, a lower frame 130, a left-side frame 140 and a right-side frame 145.

Firstly, with respect to the window frame 110, a first upper guide recess 121 is formed along a direction (y-axis direction) in which the first window 171 moves and a second upper guide recess 125 is formed along a direction (y-axis direction) in which the second window 175 moves in the upper frame 120.

The first and the second upper guide recesses 121 and 125 preferably have substantially the same shape. In the present embodiment, the first and the second upper guide recesses 121 and 125 have substantially the same shape, however, the present invention is not limited or restricted thereto. Hereinafter, the first upper guide recess 121 will be described.

The first upper guide recess 121 is divided into a sliding portion 122 and a neck portion 124.

The sliding portion 122 is used in guiding movements of the first window holder 151 and wholly or partially carrying a weight of the first window 171, which is fixed to the first window holder 151, on the upper frame 120. The sliding portion 122 is formed along the direction (y-axis direction) in which the first window 171 moves. The sliding portion 122 may have one of a variety of cross-sections. For example, the sliding portion 122 may have a cross-section resembling a circle, an oval or a polygon. The sliding portion 122 preferably has a circular cross-section to minimize friction with the first window holder 151. The neck portion 124 is formed beneath or below the sliding portion 122.

The neck portion 124 allows the sliding portion 122 to open downward so that the first window holder 151 may be suspended from the upper frame 120, and provides the first window holder 151 with a passage through which the first window holder 151 may move. The neck portion 124 is extended along an x-axis direction beneath or below the sliding portion 122, with a width smaller than that of the sliding portion 122. The neck portion 124 may have one of a variety of cross-sections. For example, the neck portion 124 may have a cross-section resembling a circle, an oval or a polygon. The neck portion 124 preferably has a quadrangular cross-section to be easily formed.

The second upper guide recess 125 is formed parallel to the first upper guide recess 121 in the upper frame 120. The second upper guide recess 125 is used in guiding movements of the second window holder 155 and wholly or partially carrying a weight of the second window 175, which is fixed to the second window holder 155, on the upper frame 120. The second upper guide recess 125 has substantially the same shape as that of the first upper guide recess 121, and thus a detailed explanation about the second upper guide recess 125 is omitted here in order to avoid repetition, however, those skilled in the art may easily understand the concepts of the present invention.

The first window holder 151 and the second window holder 155 preferably have substantially the same shape. In the present embodiment, the first and the second window holders 151 and 155 have substantially the same shape, however, the present invention is not limited or restricted thereto. Hereinafter, the first window holder 151 will be described.

The first window holder 151 is suspended from the upper frame 120. The first window holder 151 includes a suspension portion 152 inserted into the sliding portion 122, and a holding portion 154 that is extended downward from the suspension portion 152 and holds an upper part 172 of the first window 171.

The suspension portion 152 has a shape corresponding to the first upper guide recess 121, and preferably has a volume smaller than that of the sliding portion 122. The suspension portion 152 preferably has a volume larger than that of the neck portion 124 so that the first window holder 151 may not separate from the upper frame 120. For example, when the sliding portion 122 of the first upper guide recess 121 has a cylindrical shape, the suspension portion 152 may be formed to have a circular shape or a cylindrical shape with a diameter larger than the width of the neck portion 124. The holding portion 154 is extended beneath or below the suspension portion 152.

The holding portion 154 may serve as a member for holding the upper part 172 of the first window 171. The holding portion 154 is extended downward from the suspension portion 152, and is suspended from the upper frame 120 together with the suspension portion 152. The holding portion 154 has a shape of a plate on the whole, which is bent to correspond to a shape of the upper part 172 of the first window 171. Both ends of the holding portion 154 are bent along a vertical direction (z-axis direction) so that the first window 171 may be prevented from separating from the holding portion 154. The holding portion 154 has preferably a width (x-axis direction) substantially the same as that of the upper part 172 of the first window 171, and preferably a length (y-axis direction) substantially the same as or smaller than that of the first window 171.

The upper part 172 of the first window 171 may be fixed to the holding portion 154 by being forcibly fitted. Alternatively, the upper part 172 of the first window 171 may be fixed to the holding portion 154 using coupling means, such as a screw. As a result, the weight of the first window 171 may be carried by the upper frame 120.

The second window holder 155 is suspended from the upper frame 120 substantially like the first window holder 151. Additionally, the second window 175 is fixed to the second window holder 155. As a result, the weight of the second window 175 may be carried by the upper frame 120. The second window holder 155 has substantially the same shape as that of the first window holder 151, and thus a detailed explanation about the second window holder 155 is omitted here in order to avoid repetition, however, those skilled in the art may easily understand the concepts of the present invention. The weights of the first and the second windows 171 and 175 may be distributed not only to the upper frame 120 but also to the lower frame 130.

The lower frame 130 is disposed to be downwardly apart from the upper frame 120 by a height of the second window 175 (z-axis direction). One end of the upper frame 120 and one end of the lower frame 130 are connected by means of the left-side frame 140 and support each other. The other end of the upper frame 120 and the other end of the lower frame 130 are connected by means of the right-side frame 145.

The lower frame 130 has stepped portions 136 and 137, and thus a first level 131 and a second level 135 are formed in the lower frame 130. Particularly, a second stepped portion 136 is formed with a predetermined depth from an upper face of the lower frame 130 to form the second level 135, and a first stepped portion 137 is formed with a predetermined depth from an upper face of the second level 135 to form the first level 131. That is, the second stepped portion 136 defines a boundary between the upper face of the lower frame 130 and the second level 135, and the first stepped portion 137 defines a boundary between the first level 131 and the second level 135. In this case, the first and the second levels 131 and 135 have substantially the same width (x-axis direction). The stepped portions 136 and 137 form stairs on the lower frame 130 so that effects such as soundproofing, thermal insulation, prevention of rainwater inflow, etc. may be generated. A first guide cover 138 is disposed on a vertical wall of the first stepped portion 137, and a second guide cover 139 is disposed on a vertical wall of the second stepped portion 136.

The first and the second guide covers 138 and 139 preferably have substantially the same shape. In the present embodiment, the first and the second guide covers 138 and 139 have substantially the same shape, however, the present invention is not limited or restricted thereto. Hereinafter, the first guide cover 138 will be described.

The first guide cover 138 has a cross-section of an ‘L’ shape rotated clockwise by about 90°. The first guide cover 138 is extended along the direction (y-axis direction) in which the first window 171 moves, and is fixed to the left-side and the right-side frames 140 and 145. The first guide cover 138 defines a boundary of a first lower guide recess 181. Similarly, the second guide cover 139 defines a boundary of a second lower guide recess 185.

A first rail 191 is installed in the first lower guide recess 181, and a second rail 195 is installed in the second lower guide recess 185. The first and the second rails 191 and 195 guide movements of the first and the second window supports 161 and 165, respectively.

The first and the second window supports 161 and 165 preferably have substantially the same shape. In the present embodiment, the first and the second window supports 161 and 165 have substantially the same shape, however, the present invention is not limited or restricted thereto. Hereinafter, the first window support 161 will be described.

The first window support 161 includes a roller 162, a roller holder 164 and a support member 167.

The roller 162 is disposed under the first guide cover 138 in the first lower guide recess 181, and moves along the first guide cover 138. In this case, the roller 162 is surrounded by the first guide cover 138, and is prevented from separating from the first guide cover 138. The roller 162 is supported by the roller holder 164.

The roller holder 164 is formed to have a frame of a cap shape and surrounds an upper portion of the roller 162. The roller holder 164 supports the roller 162 so that the roller 162 may be disposed vertically. In this case, the roller holder 164 including the roller 162 is disposed under the first guide cover 138. The roller holder 164 is connected to the support member 167.

The support member 167 may serve as a member for holding a lower part 174 of the first window 171. The support member 167 is extended from the roller holder 164 horizontally, and is exposed on the first level 131. Particularly, the support member 167 has a shape of a bent plate on the whole. A central portion of the support member 167 is bent to cover the first guide cover 138, and both ends of the support member 167 are bent in a vertical direction so that the first window 171 may be prevented from separating from the support member 167. The support member 167 has a width substantially the same as that (x-axis direction) of the lower part 174 of the first window 171, and a length substantially the same as or smaller than that (y-axis direction) of the first window 171. In this case, the support member 167 is disposed apart from an upper face of the first level 131 and an upper face of the first guide cover 138. The support member 167 is supported by the roller holder 164 and the roller 162, and thus does not make contact with the upper face of the first level 131 or the upper face of the first guide cover 138.

The lower part 174 of the first window 171 is supported on the support member 167. In this case, the lower part 174 of the first window 171 may be fixed to the support member 167 by forcibly being fitted. Alternatively, the lower part 174 of the first window 171 may be fixed to the support member 167 using coupling means, such as a screw. As a result, the weight of the first window 171 may be supported by the lower frame 130. In this case, of course, the lower part 174 of the first window 171 has a stepped shape corresponding to the shape of the first guide cover 138 disposed on or over the lower frame 130.

The second window support 165 is installed on the lower frame 130 substantially like the first window support 161. Additionally, the second window 175 is supported on the second window support 165. As a result, the weight of the second window 175 may be supported by the lower frame 130. The second window support 165 has substantially the same shape as that of the first window support 161, and thus a detailed explanation about the second window support 165 is omitted here in order to avoid repetition, however, those skilled in the art may easily understand the concepts of the present invention.

The first window 171 moves along the first window holder 151 and the first window support 161 and may be easily opened or closed. Similarly, the second window 175 moves along the second window holder 155 and the second window support 165 and may be easily opened or closed. That is, the first and the second windows 171 and 175 may be easily opened or closed even though rollers are not directly disposed on the first and the second windows 171 and 175.

The first window 171 is fixed to a space between the first window holder 151 and the first window support 161 by an attaching/removing method. Particularly, after fixing the window frame 110, which has the window holders 151 and 155 and the window supports 161 and 165, to a structure, the first and the second windows 171 and 175 are attached to the window frame 110. That is, each of the windows 171 and 175 may be easily replaced with another one.

In the present embodiment, the first and the second windows 171 and 175 may be easily attached to or removed from the window frame 110. Additionally, the first and the second windows 171 and 175 may be attached to the window frame 110 almost irrespective of sloping or distortion of the window frame 110 because a predetermined space is formed between the first and the second windows 171 and 175 and the upper and the lower frames 120 and 130, and the weights of the first and the second windows 171 and 175 are distributed to the upper and the lower frames 120 and 130.

Further, according to some example embodiments of the present invention, rainwater does not flow into the interior of a room, and excellent effects such as soundproofing and thermal insulation may be obtained. Particularly, the window frame 110 is disposed so that the first stepped portion 137 of the lower frame 130 may face outdoors. Rainwater dropping on the lower frame 130 flows from the second level 135 to the first level 131, and from the first level 131 to the outdoors. Thus, rainwater may be effectively prevented from flowing into the interior of a room through the lower frame 130. Furthermore, substances such as dust having been collected in the lower frame 130 do not flow into the interior of a room. Thus, the lower frame 130 may be kept clean. Still furthermore, outdoor air and noise may be effectively prevented from entering the interior of a room by the stepped portions 136 and 137 formed in the lower frame 130.

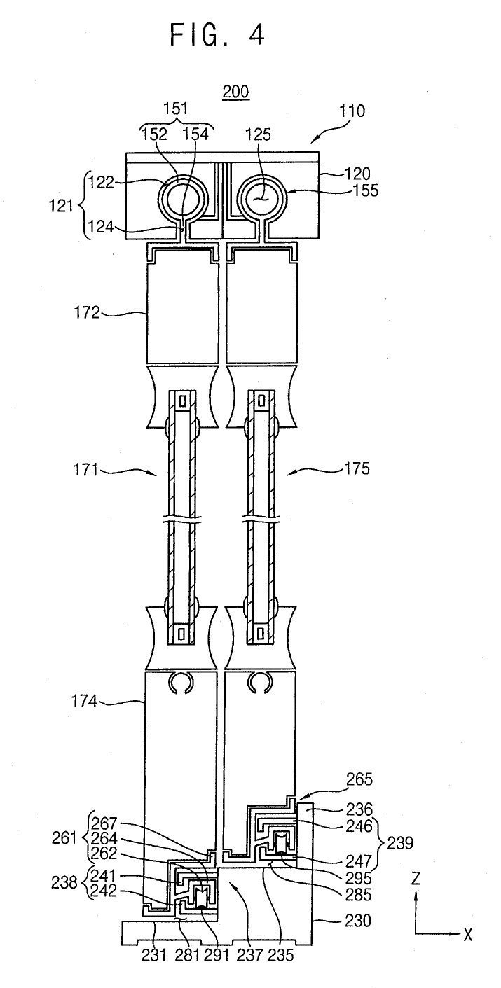

FIG. 4 is a cross-sectional view illustrating a prefabricated windows and doors system in accordance with another example embodiment of the present invention.

Further referring to FIG. 4, a prefabricated windows and doors system 200 is substantially the same as the prefabricated windows and doors system 100 in FIG. 3. Thus, like numerals refer to like elements and detailed explanations about the elements having the like numerals are omitted here, however, those skilled in the art may understand the concepts of the present invention.

A lower frame 230 has stepped portions 236 and 237, and thus a first level 231 and a second level 235 are formed in the lower frame 230. Particularly, a lower portion of the lower frame 230 under a first stepped portion 237 is the first level 231, and an upper portion of the lower frame 230 over the first stepped portion 237 is the second level 235. Additionally, the second level 235 and an upper face of the lower frame 230 are divided with the second stepped portion 236 as a boundary.

A first guide cover 238 is disposed on a vertical wall of the first stepped portion 237, and a second guide cover 239 is disposed on a vertical wall of the second stepped portion 236. A first window support 261 is installed over the first guide cover 238, and a second window support 265 is installed over the second guide cover 239.

The first and the second guide covers 238 and 239 preferably have substantially the same shape. In the present embodiment, the first and the second guide covers 238 and 239 have substantially the same shape, however, the present invention is not limited or restricted thereto. Hereinafter, the first guide covers 238 will be described.

First, with respect to the first guide cover 238, the first guide cover 238 includes a first upper guide cover 241 and a first lower guide cover 242. The first upper guide cover 241 has a cross-section of an ‘L’ shape rotated clockwise by about 90°. The first upper guide cover 241 is extended along the direction (y-axis direction) in which the first window 171 moves, and is fixed to the left-side and the right-side frames 140 and 145. The first lower guide cover 242 has a cross-section of an ‘L’ shape. The first lower guide cover 242 is extended along the direction (y-axis direction) in which the first window 171 moves, and is fixed to the left-side and the right-side frames 140 and 145. In this case, the first lower guide cover 242 has a length smaller than that of the first upper guide cover 241 (y-axis direction), and is disposed to be downwardly apart from the first upper guide cover 241 by a height of a roller 262 (z-axis direction). The first upper guide cover 241 and the first lower guide cover 242 defines a boundary of a first lower guide recess 281. A first rail 291 is installed on the first lower guide cover 242, and guides movements of the first window support 261. Similarly, the second guide cover 239 includes a second upper guide cover 246 and a second lower guide cover 247. The second upper guide cover 246 and the second lower guide cover 247 define a boundary of a second lower guide recess 285. A second rail 295 is installed on the second lower guide cover 247, and guides movements of the second window support 265.

The roller 262 of the first window support 261 is disposed between the first upper guide cover 241 and the first lower guide cover 242. The first window support 261 includes the roller 262, a roller holder 264 and a support member 267.

The roller 262 moves along the first upper guide cover 241 and the first lower guide cover 242 in the first lower guide recess 281. In this case, the roller 262 is surrounded by the first upper guide cover 241 and the first lower guide cover 242 so that the roller 262 may be prevented from separating from the first lower guide recess 281. The roller 262 is supported by the roller holder 264.

The roller holder 264 is formed to have a frame of a cap shape and surrounds an upper portion of the roller 262. The roller holder 264 supports the roller 262 so that the roller 262 may be disposed vertically. In this case, the roller holder 264 including the roller 262 is connected to the support member 267.

The support member 267 may serve as a member for holding a lower part 174 of the first window 171. The support member 267 is extended from the roller holder 264 outward of the first lower guide recess 281, and is exposed on the first level 131. The support member 267 has a shape of a bent plate on the whole. Particularly, central portion of the support member 267 is bent to cover the first upper guide cover 241, and both ends of the support member 267 are bent in a vertical direction (z-axis direction) so that the first window 171 may be prevented from separating from the support member 267.

The support member 267 has a width substantially the same as that (x-axis direction) of the lower part 174 of the first window 171, and a length substantially the same as or smaller than that (y-axis direction) of the first window 171. In this case, the support member 267 is preferably disposed apart from an upper face of the first level 231 and an upper face of the first upper guide cover 241. That is, the support member 267 is supported by the roller holder 264 and the roller 262 so that the support member 267 may not make contact with the first upper guide cover 241.

The lower part 174 of the first window 171 may be fixed onto the support member 267 by forcibly being fitted. Alternatively, the lower part 174 of the first window 171 may be fixed onto the support member 267 using coupling means, such as a screw. As a result, the weight of the first window 171 may be supported by the lower frame 230. In this case, of course, the lower part 174 of the first window 171 has a stepped shape corresponding to the shape of the first upper guide cover 241 disposed on or over the lower frame 230.

The second window support 265 is installed on the lower frame 230 substantially like the first window support 261. Additionally, the second window 175 is supported on the second window support 265. As a result, the weight of the second window 175 may be supported by the lower frame 230. The second window support 265 has substantially the same shape as that of the first window support 261, and thus a detailed explanation about the second window support 265 is omitted here in order to avoid repetition, however, those skilled in the art may easily understand the concepts of the present invention.

In the present embodiment, the window supports 261 and 265 move supported by the first and the second levels 231 and 235. Thus, the first and the second windows 171 and 175 may be opened or closed almost irrespective of sloping or distortion of the lower frame 230. Additionally, the first and the second windows 171 and 175 may be easily attached to or removed from the lower frame 230. Furthermore, rainwater may not flow into the interior of a room, and excellent effects such as soundproofing and thermal insulation may be obtained.

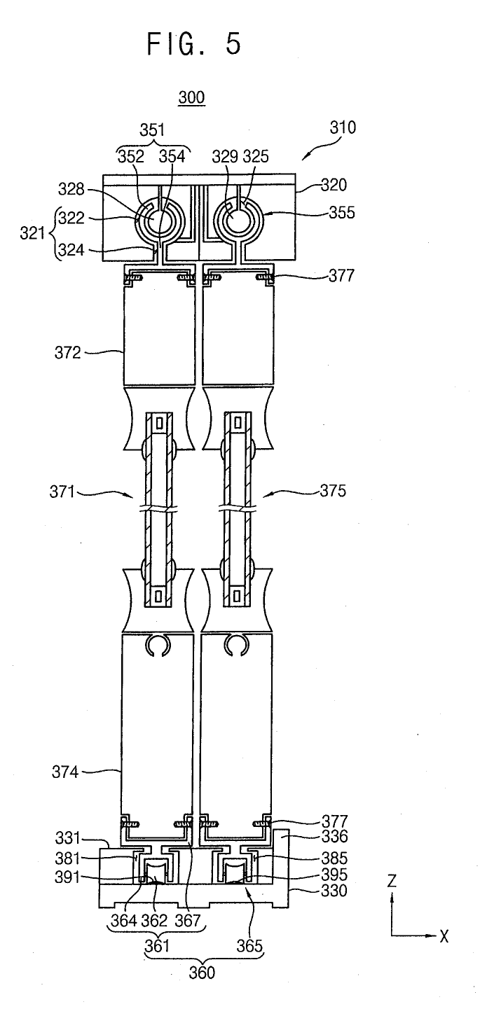

FIG. 5 is a cross-sectional view illustrating a prefabricated windows and doors system in accordance with another example embodiment of the present invention.

Referring to FIG. 5, a prefabricated windows and doors system 300 includes a window frame 310, a first window holder 351, a second window holder 355, a first window support 361, a second window support 365, a first window 371 and a second window 375.

A first upper guide recess 321 is formed along a direction (y-axis direction) in which the first window 371 moves and a second upper guide recess 325 is formed along a direction (y-axis direction) in which the second window 375 moves in the upper frame 320. The first upper guide recess 321 and the second upper guide recess 325 preferably have substantially the same shape.

In the present embodiment, the first and the second upper guide recesses 321 and 325 have substantially the same shape, however, the present invention is not limited or restricted thereto. Hereinafter, the first upper guide recess 321 will be described.

The first upper guide recess 321 is divided into a sliding portion 322 and a neck portion 324. The sliding portion 322 is formed along the direction (y-axis direction) in which the first window 371 moves. The sliding portion 322 may have one of a variety of cross-sections. For example, the sliding portion 322 may have a cross-section resembling a circle, an oval or a polygon. The sliding portion 322 preferably has a circular cross-section to minimize friction with the first window holder 351. A first guide bar 328 is formed in the first upper guide recess 321.

The first guide bar 328 guides movements of the first window holder 351, and is used in wholly or partially carrying a weight of the first window 371 on the upper frame 320. The first guide bar 328 has a shape of a tube on the whole, and is extended in a length direction (y-axis direction) of the lower frame 320. The first guide bar 328 is fixed to an inner face of the lower frame 320 so that the first guide bar 328 may be disposed in central portion of the sliding portion 322. The neck portion 324 is formed beneath or below the sliding portion 322.

The neck portion 324 opens the sliding portion 322 downward so that the first window holder 351 may be suspended from the upper frame 320, and provides the first window holder 351 with a passage through which the first window holder 351 may move. The neck portion 324 is extended along an x-axis direction with a width smaller than that of the sliding portion 322 beneath or below the sliding portion 322. The neck portion 324 may have one of a variety of cross-sections; however, the neck portion 324 preferably has a quadrangular cross-section to be easily formed.

The first window holder 351 is suspended from the upper frame 320. The first window holder 351 includes a suspension portion 352 inserted into the sliding portion 322, and a holding portion 354 that is extended downward from the suspension portion 352 and holds an upper part 372 of the first window 371.

The suspension portion 352 has a volume smaller than that of the sliding portion 322, and has a cylindrical frame shape surrounding the first guide bar 328. Particularly, the suspension portion 352 may move along the first guide bar 328, and has a partially opened cylindrical frame shape in which the suspension portion 352 has a space exposing a supporting portion of the first guide bar 328, so that the suspension portion 352 may not separate from the first guide bar 328. That is, the suspension portion 352 has a cross-section of a ring shape or a retainer ring shape. Additionally, the suspension portion 352 has a volume smaller than that of the sliding portion 322 but larger than that of the neck portion 324 so that the first window holder 351 may not separate from the upper frame 320. The holding portion 354 is extended beneath or below the suspension portion 352.

The holding portion 354 may serve as a member for holding the upper part 372 of the first window 371. The holding portion 354 is extended downward from the suspension portion 352, and is suspended from the first guide bar 328 together with the suspension portion 352. The holding portion 354 has a shape of a plate on the whole, which is bent to correspond to a shape of the upper part 372 of the first window 371. Both ends of the holding portion 354 are bent along a vertical direction (z-axis direction) so that the first window 371 may be prevented from separating from the holding portion 354. The holding portion 354 has preferably a width (x-axis direction) substantially the same as that of the upper part 372 of the first window 371, and preferably a length (y-axis direction) substantially the same as or smaller than that of the first window 371.

The upper part 372 of the first window 371 may be fixed to the holding portion 354 by being forcibly fitted. Alternatively, the upper part 372 of the first window 371 may be fixed to the holding portion 354 using coupling means, such as a screw. As a result, the weight of the first window 371 may be carried by the upper frame 320.

The second upper guide recess 325 is formed parallel to the first upper guide recess 321 in the upper frame 320. A second guide bar 329 is formed in the second upper guide recess 325. The second upper guide recess 325 is used in guiding movements of the second window holder 355 and wholly or partially carrying a weight of the second window 375, which is fixed to the second window holder 355, on the upper frame 320. The second upper guide recess 325 has substantially the same shape as that of the first upper guide recess, and thus a detailed explanation about the second upper guide recess 325 is omitted here in order to avoid repetition, however, those skilled in the art may easily understand the concepts of the present invention.

Additionally, the second window holder 355 preferably has substantially the same shape as that of the first window holder 351. In the present embodiment, the first and the second window holders 351 and 355 have substantially the same shape, however, the present invention is not limited or restricted thereto.

A stepped portion 336 is formed in the lower frame 330 for the purpose of preventing rainwater from flowing into the interior of a room, and thus the lower frame 330 may have a stepped shape. A first lower guide recess 381 is formed along the direction (y-axis direction) in which the first window 371 moves, and a second lower guide recess 385 is formed along the direction (y-axis direction) in which the second window 375 moves. The first and the second lower guide recesses 381 and 385 preferably have substantially the same shape.

In the present embodiment, the first and the second lower guide recesses 381 and 385 have substantially the same shape, however, the present invention is not limited or restricted thereto. Hereinafter, the first lower guide recess 381 will be described.

The first lower guide recess 381 is formed to have a predetermined depth from a first level 331 of the lower frame 330. The first lower guide recess 381 may have one of a variety of cross-sections. For example, the first lower guide recess 381 may have a cross-section resembling a circle, an oval or a polygon. The first window support 361 is coupled to the first lower guide recess 381. The first window support 361 includes a roller 362, a roller holder 364 and a support member 367.

The roller 362 is inserted into the first lower guide recess 381. The roller 362 moves along a first rail 391 installed in the first lower guide recess 381. The roller 362 is supported by the roller holder 364.

The roller holder 364 is formed to have a frame of a cap shape and surrounds an upper portion of the roller 362. The roller holder 364 supports the roller 362 so that the roller 362 may be disposed vertically. The roller holder 364 is connected to the support member 367.

The support member 367 may serve as a member for holding a lower part 374 of the first window 371. The support member 367 is extended from the roller holder 364 upward (z-axis direction). The support member 367 has a shape of a bent plate on the whole. The support member 367 has a width substantially the same as that (x-axis direction) of the lower part 374 of the first window 371, and a length substantially the same as or smaller than that (y-axis direction) of the first window 371. In this case, the support member 367 is preferably disposed apart from an upper face of the lower frame 330.

The lower part 374 of the first window 371 is formed to correspond to the shape of the support member 367. The lower part 374 of the first windows 371 is formed flat because the support member 367 does not have any stepped portions. Similarly, the second window support 365 is coupled to the second lower guide recess 385, and moves along a second rail 395 installed in the second lower guide recess 385.

The lower part 374 of the first window 371 may be fixed to the support member 367 by being forcibly fitted. Alternatively, the lower part 374 of the first window 371 may be fixed to the support member 367 using coupling means 377, such as a screw. As a result, the weight of the first window 371 may be supported by the lower frame 330.

The first and the second window supports 361 and 365 preferably have substantially the same shape. In the present embodiment, the first and the second window supports 361 and 365 have substantially the same shape, however, the present invention is not limited or restricted thereto.

In the present embodiment, the first and the second windows 371 and 375 are suspended from the first and the second guide bars 328 and 329 so that left and right wavering of the first and the second windows 371 and 375 may be effectively prevented, and that the weights of the first and the second windows 371 and 375 may be carried by the upper frame 320. Additionally, the first and the second windows 371 and 375 are supported using the first and the second window supports 361 and 365 so that the weights of the first and the second windows 371 and 375 may be supported by the lower frame 330. Furthermore, the lower frame 330 has a stepped shape so that rainwater may not flow into the interior of a room and excellent effects such as soundproofing and thermal insulation may be obtained.

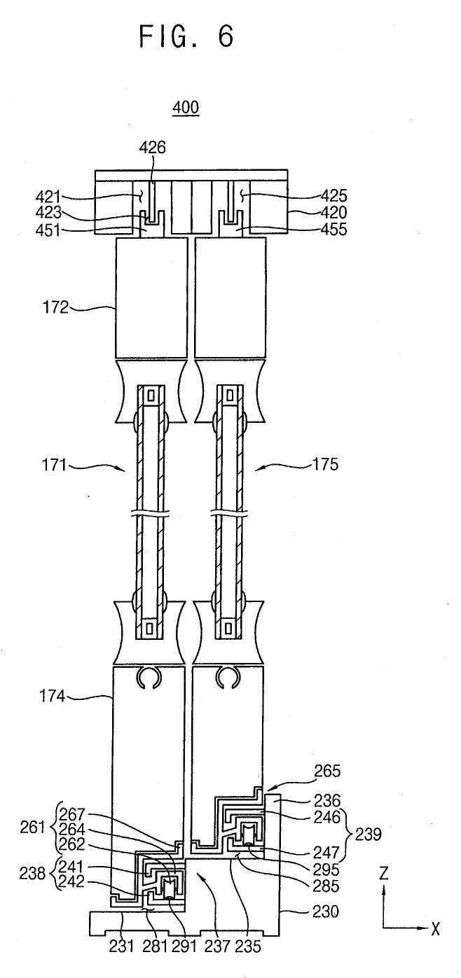

FIG. 6 is a cross-sectional view illustrating a prefabricated windows and doors system in accordance with still another example embodiment of the present invention.

Referring to FIGS. 4 and 6, a prefabricated windows and doors system 400 is substantially the same as the prefabricated windows and doors system 200 shown in FIG. 4 except for the upper frame 120, the first window holder 451 and the second window holder 455. Thus, like numerals refer to like elements and detailed explanations about the elements having the like numerals are omitted here; however, those skilled in the art may understand the concepts of the present invention.

A first upper guide recess 421 is formed along the direction (y-axis direction) in which the first window 171 moves and a second upper guide recess 425 is formed along the direction (y-axis direction) in which the second window 175 moves in the upper frame 420. The first and the second upper guide recesses 421 and 425 preferably have substantially the same shape. In the present embodiment, the first and the second upper guide recesses 421 and 425 have substantially the same shape, however, the present invention is not limited or restricted thereto. Hereinafter, the first upper guide recess 421 will be described.

The first upper guide recess 421 is used in guiding movements of the first window 171 and forming a space between the first window 171 and the upper frame 420. The first guide recess 421 is formed to have a predetermined height upwardly (z-axis direction) from a bottom face of the upper frame 420 and is extended in a length direction (y-axis direction) of the upper frame 420. A split bar 426 dividing the first upper guide recess 421 into two may be formed in the length direction of the upper frame 420 in central portion of the first upper guide recess 421. As described later, the split bar 426 may effectively prevent outdoor air and noise from entering into the interior of a room. The first window holder 451 is inserted into the first upper guide recess 421 so that the first window holder 451 may guide movements of the first window 171.

The first window holder 451 is fixed to the upper part of the first window 171, and is inserted into the first upper guide recess 421 to be disposed in the first upper guide recess 421. The first window holder 451 has a width smaller than that (x-axis direction) of the first upper guide recess 421 and a height smaller than that (z-axis direction) of the first guide recess 421. When the split bar 426 is formed in the first upper guide recess 421, a split bar recess 453 for containing the split bar 426 is formed in the first window holder 451.

The second upper guide recess 425 is formed parallel to the first upper guide recess 421 in the upper frame 420. The second upper guide recess 425 is used in guiding movements of the second window 175 and forming a space between the second window 175 and the upper frame 420. The second upper guide recess 425 has substantially the same shape as that of the first upper guide recess 421. Thus, a detailed explanation about the second upper guide recess 425 is omitted here in order to avoid repetition, however, those skilled in the art may easily understand the concepts of the present invention. A second window holder 455 is inserted into the second upper guide recess 425, and guides movements of the second window 175. In this case, the second window holder 455 has substantially the same shape as that of the first window holder 451. Thus, a detailed explanation about the second window holder 455 is omitted here in order to avoid repetition, however, those skilled in the art may easily understand the concepts of the present invention.

In the present invention, the first and the second windows 171 and 175 are supported by the first and the second window supports 261 and 265. Thus, the weights of the first and the second windows 171 and 175 are not distributed to the upper frame 420. However, a predetermined space exists between the first and the second windows 171 and 175 and the upper frame 420, and a predetermined space exists between the first and the second windows 171 and 175 and the lower frame 230, so that the first and the second windows 171 and 175 may be easily attached to or removed from the lower frame 230 almost irrespective of sloping or distortion of the lower frame 230. Additionally, manufacturing costs may be decreased, and replacement of windows may be easy. Of course, rainwater may not flow into the interior of a room, and excellent effects such as soundproofing and thermal insulation may be obtained.

Until now, a prefabricated sliding windows and doors system including two windows has been described in accordance with some example embodiments of the present invention. However, the prefabricated windows and doors system may also include more than two windows. Additionally, the prefabricated windows and doors system may serve as a double sliding window, a porch door, an interior door, a multi-stage window, etc.

### INDUSTRIAL APPLICABILITY

According to the present invention, after installing an upper sliding member and a lower sliding member in a window frame, windows are coupled to the window frame. Additionally, weights of the windows are distributed to an upper frame and a lower frame of the window frame. Thus, the windows may be attached to or removed from the window frame irrespective of sloping or distortion of the window frame. Additionally, the lower frame has a stepped shape so that rainwater may not flow into the interior of a room and that excellent effects such as soundproofing and thermal insulation may be obtained.

1. A prefabricated windows and doors system, comprising:
a window frame including an upper frame and a lower frame, wherein the upper frame has an upper guide recess formed in a sliding direction of a window, wherein the lower frame contains a stepped portion to have a staircase shape and contains a lower guide recess on a sidewall of the stepped portion, and wherein a rail is formed in the lower guide recess;
a window holder slidably inserted into the upper guide recess to be suspended from the upper frame;
a window support slidably inserted into the lower guide recess to support a roller on the rail, the roller configured to be rotatable; and
the window coupled to the window holder and the window support, the window configured to be attachable to or removable from the window holder and the window support.

2. The system of claim 1, wherein the upper guide recess includes a sliding portion and a neck portion, the sliding portion configured to have a cylindrical shape, and the neck portion configured to be extended downward from the sliding portion and have a width smaller than that of the sliding portion.

3. The system of claim 1, wherein the window holder includes a suspension portion and a holding portion, the suspension portion configured to slide along the upper guide recess, and the holding portion configured to be extended downward from the suspension portion and have a quadrangular frame shape with a width substantially the same as that of an upper part of the window so that the window is fixed to the holding portion by being forcibly fitted.

4. The system of claim 3, further comprising a guide bar extended in the sliding direction of the window in the upper guide recess,
wherein the suspension portion has a ring shape surrounding the guide bar.

5. The system of claim 1, wherein the window support includes a roller holder and a support member, the roller holder configured to support the roller, the roller configured to be rotatable, and the support member configured to be extended outward of the lower guide recess and have a quadrangular frame shape with a width substantially the same as that of a lower part of the window so that the window is fixed to the support member by being forcibly fitted.

6. The system of claim 1, further comprising a guide cover having a cross-section of an ‘L’ shape rotated clockwise by about 90°, the guide cover configured to be installed on a vertical wall of the stepped portion to define a boundary of the lower guide recess.

7. The system of claim 6, wherein the lower part of the window has a stepped shape corresponding to a shape of the guide cover.

8. The system of claim 1, further comprising:
a lower guide cover having a cross-section of an ‘L’ shape, the lower guide cover configured to be installed on the vertical wall of the stepped portion to support the roller; and
an upper guide cover having a cross-section of an ‘L’ shape rotated clockwise by about 90°, the upper guide cover configured to be installed on the vertical wall of the stepped portion and over the lower guide cover with a width larger than that of the lower guide cover to define a boundary of the lower guide recess.

9. The system of claim 1, wherein the window frame further comprises side frames for connecting each end of the upper frame and each end of the lower frame, respectively, to support the upper and the lower frames.

10. A prefabricated windows and doors system, comprising:
a window frame including an upper frame and a lower frame, wherein the upper frame has an upper guide recess formed in a sliding direction of a window, wherein the lower frame has a lower guide recess formed in the sliding direction of the window, and wherein a rail is formed in the lower guide recess;
a window holder slidably inserted into the upper guide recess to be suspended from the upper frame;
a window support slidably inserted into the lower guide recess to support a roller on the rail, the roller configured to be rotatable; and
the window coupled to the window holder and the window support, the window configured to be attachable to or removable from the window holder and the window support.

11. A prefabricated windows and doors system, comprising:
a window frame including an upper frame and a lower frame, wherein the upper frame has an upper guide recess formed in a sliding direction of a window, wherein the lower frame contains a stepped portion to have a staircase shape and contains a lower guide recess on a sidewall of the stepped portion, and wherein a rail is formed in the lower guide recess;
a window support slidably inserted into the lower guide recess to support a roller on the rail, the roller configured to be rotatable; and
the window coupled to the window holder and the window support, wherein a lower part of the window is attachable to or removable from the window support and an upper part of the window is fitted into the upper guide recess.
